(19) United States
(12) Patent Application Publication
(10) Pub. No.: US 2019/0297127 A1
(43) Pub. Date: Sep. 26, 2019

(54) SYSTEMS, METHODS AND DEVICES FOR OPERATOR CONTROL UNIT BASED VOIP COMMUNICATION

(71) Applicant: Laird Technologies, Inc., Chesterfield, MO (US)

(72) Inventor: Jeremy JOVENALL, Mercer, PA (US)

(21) Appl. No.: 16/106,751

(22) Filed: Aug. 21, 2018

Related U.S. Application Data
(60) Provisional application No. 62/646,346, filed on Mar. 21, 2018.

(51) Int. Cl. H04L 29/06; H04L 29/08; B61L 3/12

(52) U.S. Cl. CPC H04L 65/4061; H04L 65/4076; H04L 67/18; B61L 2205/00; B61L 3/127; B61L 3/125; H04L 67/125

(57) ABSTRACT

According to various aspects, exemplary embodiments are disclosed of systems, methods and devices related to operator control unit base VOIP communication. In an exemplary embodiment, an operator control unit based VOIP communication system includes an operator control unit in wireless communication with a locomotive control unit coupled to a locomotive to control operation of the locomotive. The operator control unit includes a first wireless interface to transmit one or more commands to the locomotive control unit, and an auxiliary wireless interface. The system also includes a microphone in communication with the operator control unit. The operator control unit is configured to receive voice signals from the microphone, and to transmit voice data corresponding to the received voice signals via the auxiliary wireless interface. The voice data is transmitted by the auxiliary wireless interface though a railyard infrastructure wireless network using a voice over internet protocol (VOIP).

### CROSS-REFERENCE TO RELATED APPLICATION

This application claims the benefit of U.S. Provisional Application No. 62/646,346 filed Mar. 21, 2018. The entire disclosure of the above application is incorporated herein by reference.

### FIELD

The present disclosure generally relates to systems, methods and devices for operator control unit based VOIP communication.

### BACKGROUND

This section provides background information related to the present disclosure which is not necessarily prior art.

In current operation of modern rail yards, remote control locomotive (RCL) systems require operators to carry an operator control unit (OCU) strapped to their vest and a two-way radio strapped to their belt. Typically, an external speaker/microphone is attached to the operator's shoulder.

### DRAWINGS

The drawings described herein are for illustrative purposes only of selected embodiments and not all possible implementations, and are not intended to limit the scope of the present disclosure.

FIG. 1 is a block diagram of an operator control unit based VOIP communication system according to one example embodiment of the present disclosure;

FIG. 2 is a block diagram of an operator control unit based VOIP communication system including a mobile computing device base unit, according to another example embodiment of the present disclosure;

FIG. 3 is a block diagram of the example mobile computing device base unit shown in FIG. 2; and

FIG. 4 is a block diagram of the example operator control unit shown in FIG. 2.

Corresponding reference numerals indicate corresponding parts throughout the several views of the drawings

### DETAILED DESCRIPTION

Example embodiments will now be described more fully with reference to the accompanying drawings.

The inventor has recognized that in current operation of modern rail yards, remote control locomotive (RCL) systems require operators to carry an operator control unit (OCU) strapped to their vest and a two-way radio strapped to their belt. Typically, an external speaker/microphone is attached to the operator's shoulder.

Disclosed herein are exemplary embodiments of systems, methods and devices for operator control unit based Voice Over Internet Protocol (VOIP) communication. In some embodiments, an operator no longer needs to use a two-way radio because the operator uses the operator control unit to facilitate a Voice Over IP data transmission network.

For example, an operator control unit may be equipped with one or more auxiliary wireless interfaces (e.g., data ports), such as a short-range wireless communication interface, a Wi-Fi wireless communication interface, etc. The inventor has recognized the auxiliary wireless interface of the operator control unit can function as a VOIP system for voice communication in a rail yard.

The inventor has also recognized that for yard workers who do not operate remote controls (e.g., do not carry an operator control unit), a mobile computing device could be used for VOIP communication. In some cases, the mobile computing device may be a small device having a comparable size and weight to a two-way radio.

In some embodiments, a microphone (e.g., sitting on an operator's shoulder, etc.) could be wired to a base unit (e.g., an operator control unit and/or a mobile computing device). Alternatively, or in addition, the microphone could be wirelessly connected to the base unit.

In the case of a mobile computing device base unit, the mobile computing device could include a VOIP radio, a battery and support hardware in a small enclosure. The operator control units and/or mobile computing devices connect to and route VOIP traffic through a yard infrastructure such as Wi-Fi, etc.

An operator control unit may include a global navigation satellite system (GNSS) antenna (e.g., a GPS antenna, etc.), one or more accelerometers (e.g., an accelerometer array, a single accelerometer, etc.), etc. Similarly, a mobile computing device base unit may be equipped with a GNSS antenna, one or more accelerometers (e.g., an accelerometer array, a single accelerometer, etc.) for tilt detection and other suitable functions. In some embodiments, the mobile computing device base unit may be mounted on a belt of an operator.

The operator control units and/or mobile computing devices can report a location, one or more parameters, etc. to a wireless network for back office monitoring and data processing. Using a VOIP setup can permit selective data transfers where messages can be broadcast to an entire railyard, and/or sent to specific connections such as fellow crew members, yard management, etc.

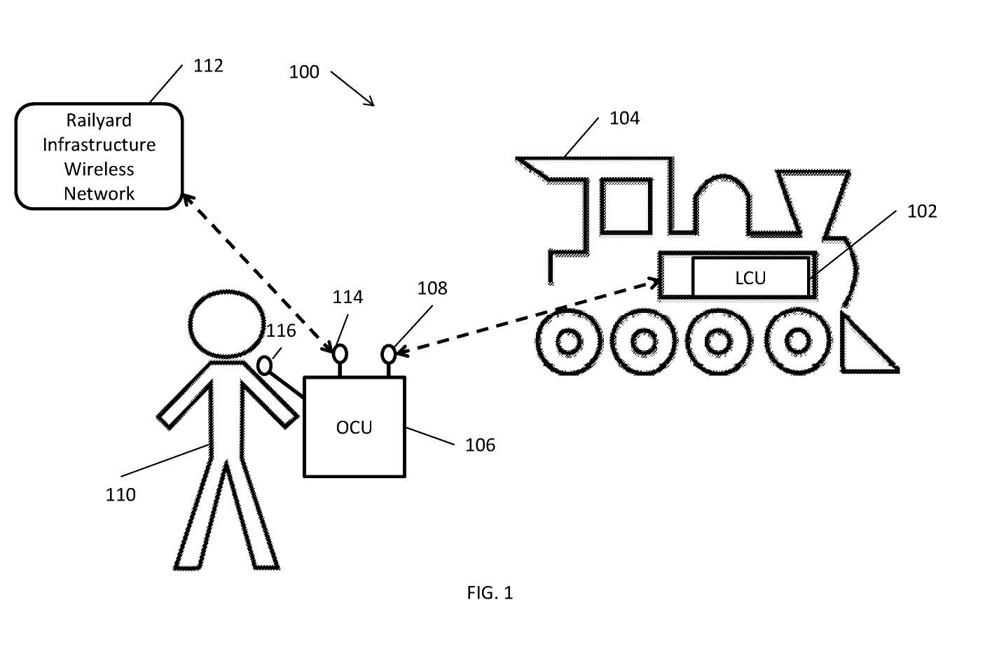

With reference to the figures, FIG. 1 illustrates an example operator control unit based VOIP communication system 100 according to some aspects of the present disclosure. The system 100 includes a locomotive control unit 102 coupled to a locomotive 104. The locomotive control unit 102 is configured to control operation of the locomotive 104, and may include any suitable locomotive control unit (e.g., machine control unit, etc.) as described herein.

The system 100 also includes an operator control unit 106 in wireless communication with the locomotive control unit 102. The operator control unit 106 includes a first wireless interface 108 configured to transmit one or more commands to the locomotive control unit 102. For example, as described herein, the operator control unit 106 may receive commands from an operator 110, and transmit the commands to the locomotive control unit 102 to control the locomotive 104.

The system 100 further includes a microphone 116 in communication with the operator control unit 106. For example, the microphone 116 may be wired to the operator control unit 106, the microphone 116 may be in wireless communication with the operator control unit 106, etc.

As shown in FIG. 1, the system 100 also includes a railyard infrastructure wireless network 112. The operator control unit 106 is in wireless communication with the railyard infrastructure wireless network 112 via an auxiliary wireless interface 114 of the operator control unit 106.

The operator control unit 106 is configured to receive voice signals from the microphone 116, and to transmit voice data corresponding to the received voice signals via the auxiliary wireless interface 114. The voice data is transmitted by the auxiliary wireless interface 114 to the railyard infrastructure wireless network 112 using a voice over internet protocol (VOIP).

As described above, the operator control unit 106 includes a first wireless interface 108 and an auxiliary wireless interface 114. The first wireless interface 108 may be separate from the auxiliary wireless interface 114, and may operate according to a different wireless communication protocol.

For example, the first wireless interface 108 may be a radio frequency (RF) wireless interface for establishing an RF communication channel between the operator control unit 106 and the locomotive control unit 102. The auxiliary wireless interface 114 may be a Wi-Fi wireless communication interface, etc. for establishing voice over internet protocol (VOIP) communication between the operator control unit 106 and the railyard infrastructure wireless network 112. Therefore, the operator control unit 106 may communicate with the locomotive control unit 102 and the railyard infrastructure wireless network 112 via separate wireless communication channels.

The VOIP communication system 100 allows the operator control unit 106 to control where voice data is transmitted. For example, the operator control unit 106 may be configured to broadcast the voice data via VOIP to all communication devices connected to the railyard infrastructure wireless network 112. Additionally, or alternatively, the operator control unit 106 may be configured to transmit the voice data via VOIP to only a specified subset of all communication devices connected to the railyard infrastructure wireless network 112.

In some embodiments, the operator control unit 106 is configured to report a location of the operator control unit 106, a status parameter of the operator control unit 106, etc. to the railyard infrastructure wireless network 112. This can allow other device(s) connected to the railyard infrastructure wireless network 112 to provide back office monitoring, data processing, etc. related to the operator control unit 106.

As described herein, the VOIP communication system 100 may allow the operator 110 to avoid the need to carry a two-way radio for voice communication. For example, the operator 110 may simply use the VOIP communication features of the operator control units described herein for voice communication. In that case, the system 100 may not include any two-way radios for voice communication.

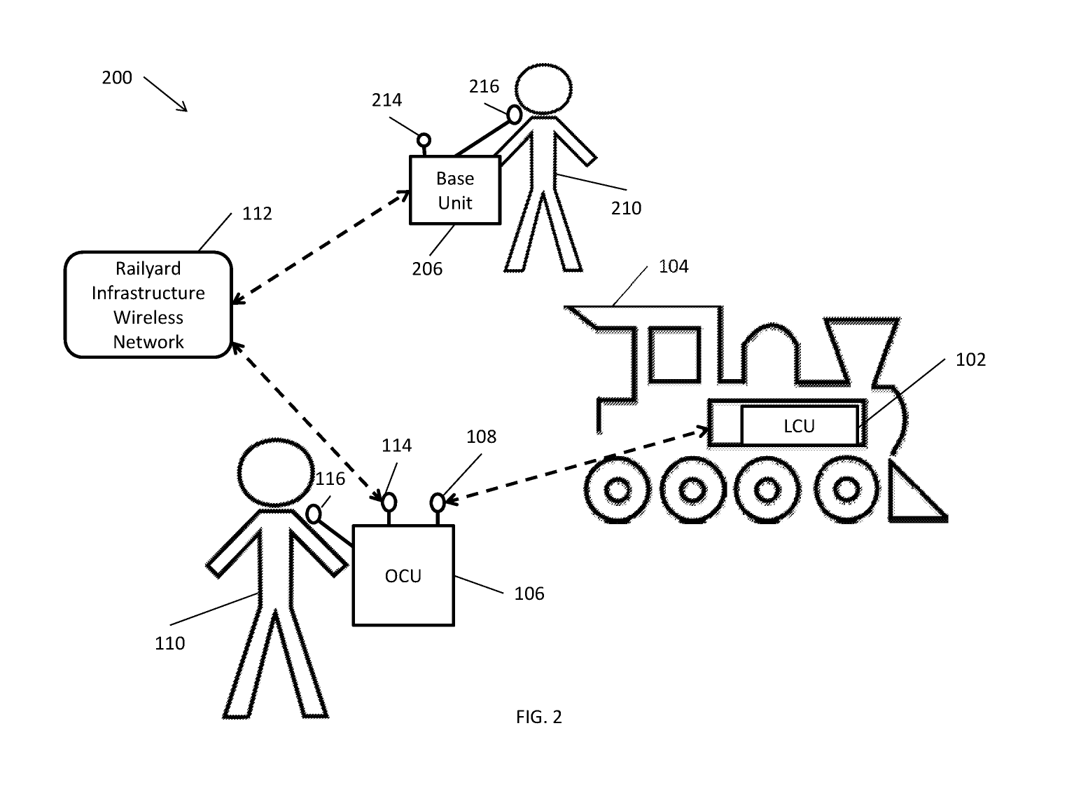

FIG. 2 illustrates an example system 200 according to another example embodiment of the present disclosure. The system 200 is similar to the system 100 of FIG. 1, but further includes a mobile computing device base unit 206. The mobile computing device base unit 206 is carried by an operator 210 that does not have an operator control unit.

As shown in FIG. 2, the mobile computing device base unit 206 includes a VOIP radio 214. A second microphone 216 is in communication with the mobile computing device base unit 206. The mobile computing device base unit 206 is configured to receive voice signals from the second microphone 216, and to transmit voice data corresponding to the received voice signals from the second microphone 216 via the VOIP radio 214. The voice data corresponding to the received voice signals from the second microphone 216 is transmitted by the VOIP radio 214 to the railyard infrastructure wireless network 112 using the voice over internet protocol.

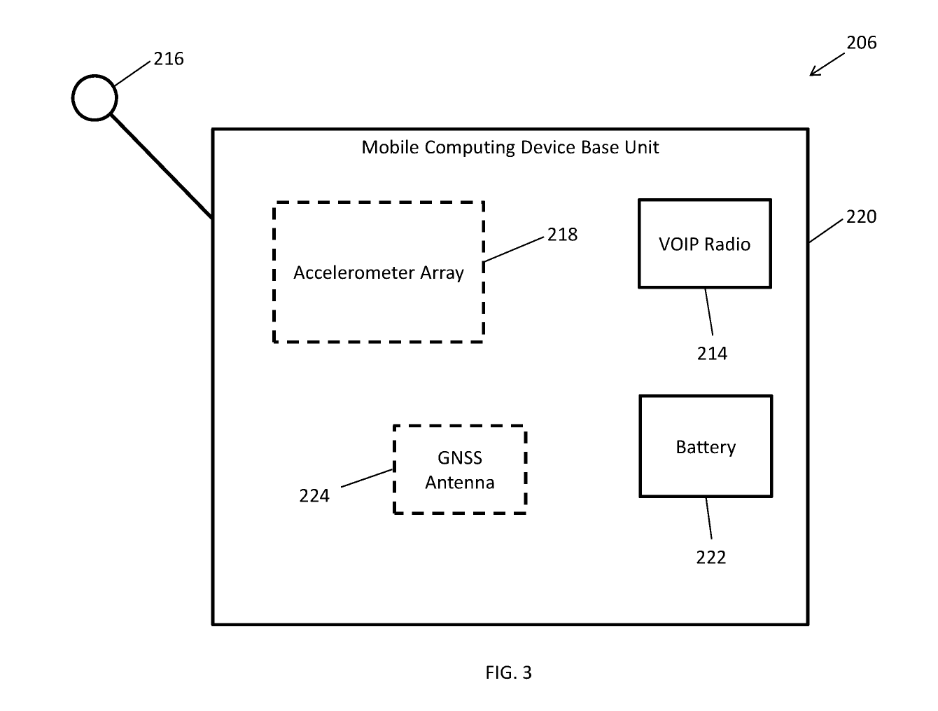

FIG. 3 illustrates a block diagram of the mobile computing device base unit 206 shown in FIG. 2. The mobile computing device base unit 206 includes a housing 220, the VOIP radio 214, and a battery 222 located inside the housing 220. The mobile computing device base unit 206 is connected to the microphone 216. Although FIG. 3 illustrates a wired connection between the microphone 216 and the mobile computing device base unit 206, other embodiments may include a wireless connection between the mobile computing device base unit 206 and the microphone 216.

As shown in FIG. 3, the mobile computing device base unit 206 optionally includes a global navigation satellite system (GNSS) antenna 224 for determining a location of the mobile computing device base unit 206. For example, the GNSS antenna 224 may be a global positioning system (GPS) antenna. In that case, the mobile computing device base unit 206 may be configured to report a location of the mobile computing device base unit 206, a parameter of the mobile computing device base unit 206, etc. to the railyard infrastructure wireless network 112 for back office monitoring and/or data processing.

The mobile computing device base unit 206 optionally includes an accelerometer array 218 for tilt detection. For example, the mobile computing device base unit 206 may detect a fall (e.g., tilt) event using the accelerometer array 218, and may transmit the fall/tilt event via the VOIP radio 214.

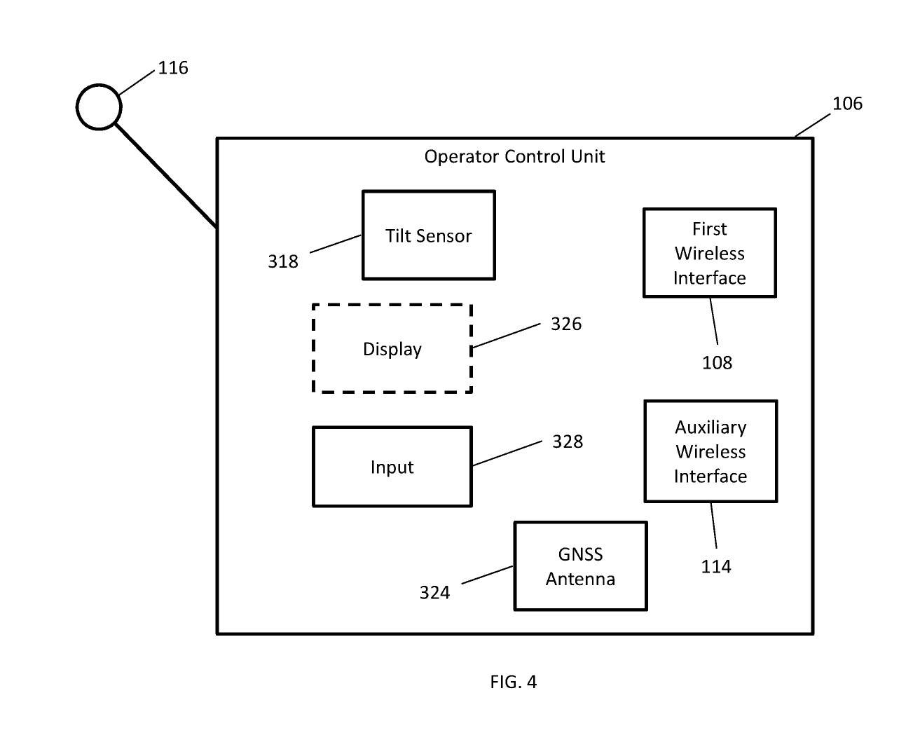

FIG. 4 illustrates a block diagram of the operator control unit 106 shown in FIGS. 1 and 2. The operator control unit 106 includes an optional display 326, and an input 328. The optional display 326 can be any suitable display (e.g., a liquid crystal display (LCD), light emitting diodes (LED), indicator lights, etc.). The input 328 can include any suitable input element(s) (e.g., a keypad, touchscreen, switches, etc.), for receiving inputs (e.g., commands, etc.) from the operator 110.

The operator control unit 106 is connected to the microphone 116. Although FIG. 4 illustrates a wired connection between the microphone 116 and the operator control unit 106, other embodiments may include a wireless connection between the operator control unit 106 and the microphone 116.

As described above, the operator control unit 106 also includes a first wireless interface 108 and an auxiliary wireless interface 114. The first wireless interface 108 may communicate with the locomotive control unit 102 via an RF channel, and the auxiliary wireless interface 114 may communicate with the railyard infrastructure wireless network 112 using VOIP via a Wi-Fi connection, etc.

The operator control unit 106 may include a global navigation satellite system (GNSS) antenna 324 for determining a location of the operator control unit 106. For example, the GNSS antenna 324 may be a global positioning system (GPS) antenna. Additionally, or alternatively, the operator control unit 106 can include a tilt sensor 318. For example, the operator control unit 106 may be configured to transmit an emergency brake command to the locomotive control unit 102 when the tilt sensor 318 detects a tilt event for a specified tilt duration of time (e.g., five seconds, thirty seconds, one minute, etc.). Additionally, or alternatively, the operator control unit 106 could include an emergency stop button.

As described herein, the example operator control units and mobile computing device base units may include a microprocessor, microcontroller, integrated circuit, digital signal processor, etc., which may include memory. The operator control units and mobile computing device base units may be configured to perform (e.g., operable to perform, etc.) any of the example processes described herein using any suitable hardware and/or software implementation. For example, the operator control units and mobile computing device base units may execute computer-executable instructions stored in a memory, may include one or more logic gates, control circuitry, etc.

According to another example embodiment, a mobile computing device base unit includes an enclosure, a voice over internet protocol (VOIP) radio housed in the enclosure, and a battery housed in the enclosure. The mobile computing device base unit is configured to receive voice signals from a microphone.

The mobile computing device base unit is also configured to transmit voice data corresponding to the received voice signals from the microphone via the VOIP radio. The voice data corresponding to the received voice signals from the microphone is transmitted by the VOIP radio though a railyard infrastructure wireless network using a voice over internet protocol.

In some embodiments, the mobile computing device base unit includes a global navigation satellite system antenna, one or more accelerometers (e.g., an accelerometer array, a single accelerometer, etc.) for tilt detection, etc. The mobile computing device base unit may be configured to report a location of the mobile computing device base unit, a parameter of the mobile computing device base unit, etc. to the railyard infrastructure wireless network for back office monitoring and/or data processing

According to another example embodiment, an exemplary method of providing VOIP communication using an operator control unit is disclosed. The operator control unit is in wireless communication with a locomotive control unit coupled to a locomotive to control operation of the locomotive. The operator control unit includes a first wireless interface and an auxiliary wireless interface, and a microphone is in communication with the operator control unit.

The exemplary method generally includes transmitting one or more commands to the locomotive control unit via the first wireless interface to control the locomotive, and receiving voice signals from the microphone. The method also includes transmitting voice data corresponding to the received voice signals via the auxiliary wireless interface. The voice data is transmitted by the auxiliary wireless interface though a railyard infrastructure wireless network using a voice over internet protocol (VOIP).

In some embodiments, the auxiliary wireless interface includes a Wi-Fi wireless communication interface. The method may include reporting a location of the operator control unit, a parameter of the operator control unit, etc. to the railyard infrastructure wireless network for back office monitoring and/or data processing.

In some cases, the method may include receiving, by a mobile computing device base unit having a VOIP radio, voice signals from a second microphone. The method may further include transmitting, by the mobile computing device base unit, voice data corresponding to the received voice signals from the second microphone via the VOIP radio. The voice data corresponding to the received voice signals from the second microphone can be transmitted by the VOIP radio though the railyard infrastructure wireless network using the voice over internet protocol.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purposes of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An operator control unit based VOIP communication system, comprising:
an operator control unit in wireless communication with a locomotive control unit coupled to a locomotive to control operation of the locomotive, the operator control unit including a first wireless interface to transmit one or more commands to the locomotive control unit, and an auxiliary wireless interface; and
a microphone in communication with the operator control unit, the operator control unit configured to receive voice signals from the microphone, and to transmit voice data corresponding to the received voice signals via the auxiliary wireless interface, wherein the voice data is transmitted by the auxiliary wireless interface though a railyard infrastructure wireless network using a voice over internet protocol (VOIP).

2. The system of claim 1, wherein the auxiliary wireless interface includes a Wi-Fi wireless communication interface.

3. The system of claim 1, wherein the first wireless interface is a radio frequency wireless interface.

4. The system of claim 1, wherein the microphone is wired to the operator control unit.

5. The system of claim 1, wherein the microphone is in wireless communication with the operator control unit.

6. The system of claim 1, wherein the operator control unit is configured to broadcast the voice data via VOIP to all communication devices connected to the railyard infrastructure wireless network.

7. The system of claim 1, wherein the operator control unit is configured to transmit the voice data via VOIP to only a specified subset of all communication devices connected to the railyard infrastructure wireless network.

8. The system of claim 1, wherein the operator control unit is configured to report at least one of a location of the operator control unit and a parameter of the operator control unit to the railyard infrastructure wireless network for back office monitoring and/or data processing.

9. The system of claim 1, wherein the system does not include a two-way radio for voice communication.

10. The system of claim 1, further comprising:
a mobile computing device base unit having a VOIP radio and a battery housed in an enclosure; and
a second microphone in communication with the mobile computing device base unit, the mobile computing device base unit configured to receive voice signals from the second microphone, and to transmit voice data corresponding to the received voice signals from the second microphone via the VOIP radio, wherein the voice data corresponding to the received voice signals from the second microphone is transmitted by the VOIP radio though the railyard infrastructure wireless network using the voice over internet protocol.

11. The system of claim 10, wherein the mobile computing device base unit includes at least one of a global navigation satellite system antenna and one or more accelerometers for tilt detection.

12. The system of claim 10, wherein the mobile computing device base unit is configured to report at least one of a location of the mobile computing device base unit and a parameter of the mobile computing device base unit to the railyard infrastructure wireless network for back office monitoring and/or data processing.

13. The system of claim 1, further comprising the locomotive control unit coupled to the locomotive.

14. A method of providing VOIP communication using an operator control unit, the operator control unit in wireless communication with a locomotive control unit coupled to a locomotive to control operation of the locomotive, the operator control unit including a first wireless interface and an auxiliary wireless interface, a microphone in communication with the operator control unit, the method comprising:
transmitting one or more commands to the locomotive control unit via the first wireless interface to control the locomotive;
receiving voice signals from the microphone; and
transmitting voice data corresponding to the received voice signals via the auxiliary wireless interface, wherein the voice data is transmitted by the auxiliary wireless interface though a railyard infrastructure wireless network using a voice over internet protocol (VOIP).

15. The method of claim 14, wherein the auxiliary wireless interface includes a Wi-Fi wireless communication interface.

16. The method of claim 14, further comprising reporting at least one of a location of the operator control unit and a parameter of the operator control unit to the railyard infrastructure wireless network for back office monitoring and/or data processing.

17. The method of claim 14, further comprising:
receiving, by a mobile computing device base unit having a VOIP radio, voice signals from a second microphone; and
transmitting, by the mobile computing device base unit, voice data corresponding to the received voice signals from the second microphone via the VOIP radio, wherein the voice data corresponding to the received voice signals from the second microphone is transmitted by the VOIP radio though the railyard infrastructure wireless network using the voice over internet protocol.

18. A mobile computing device base unit comprising:
an enclosure;
a voice over internet protocol (VOIP) radio housed in the enclosure; and
a battery housed in the enclosure, wherein:
the mobile computing device base unit is configured to receive voice signals from a microphone; and
the mobile computing device base unit is configured to transmit voice data corresponding to the received voice signals from the microphone via the VOIP radio, wherein the voice data corresponding to the received voice signals from the microphone is transmitted by the VOIP radio though a railyard infrastructure wireless network using a voice over internet protocol.

19. The mobile computing device base unit of claim 18, further comprising at least one of a global navigation satellite system antenna and one or more accelerometers for tilt detection.

20. The mobile computing device base unit of claim 18, wherein the mobile computing device base unit is configured to report at least one of a location of the mobile computing device base unit and a parameter of the mobile computing device base unit to the railyard infrastructure wireless network for back office monitoring and/or data processing.
